(19) United States
(12) Patent Application Publication
(10) Pub. No.: US 2008/0072218 A1
(43) Pub. Date: Mar. 20, 2008

(54) APPARATUS AND METHOD FOR UPGRADING SOFTWARE IN PORTABLE TERMINAL

(75) Inventor: Hye-Jung KWON, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTONICS CO., LTD., Suwon-si (KR)

(21) Appl. No.: 11/858,037

(22) Filed: Sep. 19, 2007

(30) Foreign Application Priority Data
Sep. 19, 2006 (KR) 2006-0090789

(51) Int. Cl. G06F 9/445; G06F 9/44

(52) U.S. Cl. 717/173; 717/169

(57) ABSTRACT

Disclosed is an apparatus and method for upgrading software in a portable terminal. The method includes determining if additional installation files for the software upgrade are downloaded, storing the additional installation file in an additional installation region of a memory without discrimination between software modules, and storing the matching information of the additional installation files and the software modules.

### PRIORITY

This application claims priority under 35 U.S.C. § 119(a) to an application filed in the Korean Intellectual Property Office on Sep. 19, 2006 and allocated Serial No. 2006-90789, the contents of which are incorporated herein by reference.

### BACKGROUND OF THE INVENTION

1. Field of the Invention

The present invention relates generally to an apparatus and method for upgrading software in a portable terminal, and more particularly, to an apparatus and method for providing an efficient use of memory when upgrading software in a portable terminal.

2. Description of the Related Art

Because of their convenience, portable terminals have rapidly increased in usage and have become indispensable articles for modern living. Service providers and terminal manufacturers provide a variety of additional functions and services to further increase the usability of the portable terminals. Examples of the additional functions and services are a phone book function, a Short Message Service (SMS), a voice message service, a Multimedia Message Service (MMS), a cell broadcasting service, an Internet service, an e-mail service, a morning call or wake-up function, an MP3 (MPEG Layer 3) function, a digital camera function, a game function, and a scheduler function.

The portable terminals store a variety of software programs in a built-in memory in order to provide the additional functions and services. The service providers continuously improve the existing software programs in order to provide more convenient functions and services. Accordingly, the service providers provide users with a method for upgrading the existing software programs. Therefore, the users can upgrade the existing software programs into improved software programs by adding delta files to the existing software programs, which is called a “firmware upgrade”.

FIGS. 1A and 1B are diagrams illustrating an example of the memory usage for software upgrade in a conventional portable terminal.

FIG. 1A illustrates the usage of an auxiliary memory 110 before and after the software upgrade. The auxiliary memory 110 is used to store an Operating System (OS) program and software programs such as application programs. For example, a hard disk, a floppy disk, a magnetic tape or a flash memory may be used as the auxiliary memory 110. For portability, the flash memory is used as an auxiliary memory in most portable terminals. Referring to FIG. 1A, software programs are stored in the auxiliary memory 110 in such a way that a predetermined reserved space is allocated to each software module. The reserved space is a space that is reserved to store a delta file for the software upgrade. The size of the reserved space is predetermined at the installation of the software program in order to facilitate the software upgrade. As illustrated in FIG. 1A, the delta file for each software module is stored in the corresponding reserved space at the software upgrade.

FIG. 1B illustrates the uses of the auxiliary memory 110 and a main memory 130 at the execution of the software program. The main memory 130 is used to temporarily store the OS program, an application program for a desired task, and data that is generated during the execution of the application program. Referring to FIG. 1B, the software program stored in the auxiliary memory 110 is loaded into the main memory 130 for the software execution. At this point, the corresponding reserved space is loaded together with the software program, regardless of the presence of the corresponding delta file.

As described above, the reserved space for the software upgrade is allocated to each software module in the auxiliary memory of the conventional portable terminal. However, the allocation of the reserved space to each software module leads to a waste of the auxiliary memory. In addition, the main memory is wasted due to the loading of the reserved space into the main memory together with the software program. Furthermore, if the size of the delta file is larger than the predetermined size of the corresponding reserved space, it is impossible to store the larger-size delta file.

### SUMMARY OF THE INVENTION

An object of the present invention is to substantially solve at least the above problems and/or disadvantages and to provide at least the advantages below. Accordingly, an object of the present invention is to provide an apparatus and method for preventing a memory waste in a portable terminal.

Another object of the present invention is to provide an apparatus and method for storing a delta file with a size larger than a reserved memory space when upgrading a corresponding software program in a portable terminal.

Still another object of the present invention is to provide an apparatus and method for loading a software program stored in an auxiliary memory into a main memory in a portable terminal.

According to one aspect of the present invention, a method for upgrading software in a portable terminal includes determining if delta files for the software upgrade are downloaded; storing the delta files in a delta region of a memory without discrimination between software modules; and storing the matching information of the delta files and the software modules.

According to another aspect of the present invention, a method for executing software in a portable terminal includes matching a delta file to a corresponding software module stored in a first memory; loading the software module upgraded with the delta file into a second memory; and executing the upgraded software.

According to still another aspect of the present invention, a portable terminal includes a memory for storing software modules and delta files; and a controller performing a control operation for storing the delta files in a delta region of the memory without discrimination between the software modules corresponding to the delta files and a control operation for storing the matching information of the delta files and the corresponding software modules.

According to even another aspect of the present invention, a portable terminal includes a first memory for storing software modules and delta files; a second memory for storing the software modules and the delta files temporarily for software execution; and a controller performing a control operation for matching the delta files to the corresponding software modules and a control operation for storing the software modules upgraded with the corresponding delta files into the second memory.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B are diagrams of an example of the uses of memories for software upgrade in a conventional portable terminal;

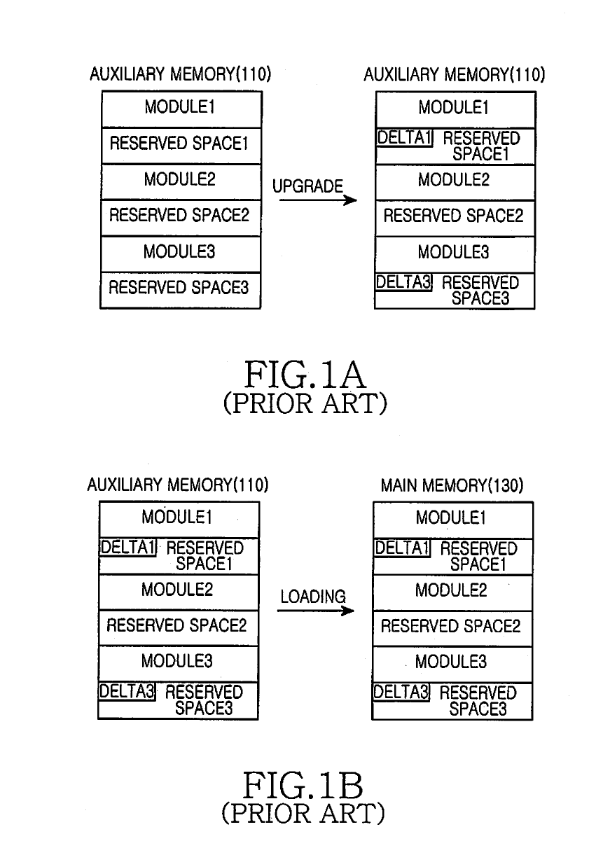

FIG. 2 is a block diagram of a portable terminal according to the present invention;

FIG. 3 is a flowchart of a procedure for upgrading software in the portable terminal according to the present invention;

FIG. 4 is a flowchart of a procedure for executing the upgraded software in the portable terminal according to the present invention; and

FIGS. 5A and 5B are diagrams of the use of memories for software upgrade in the portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides technologies for upgrading software and loading the upgraded software in a portable terminal.

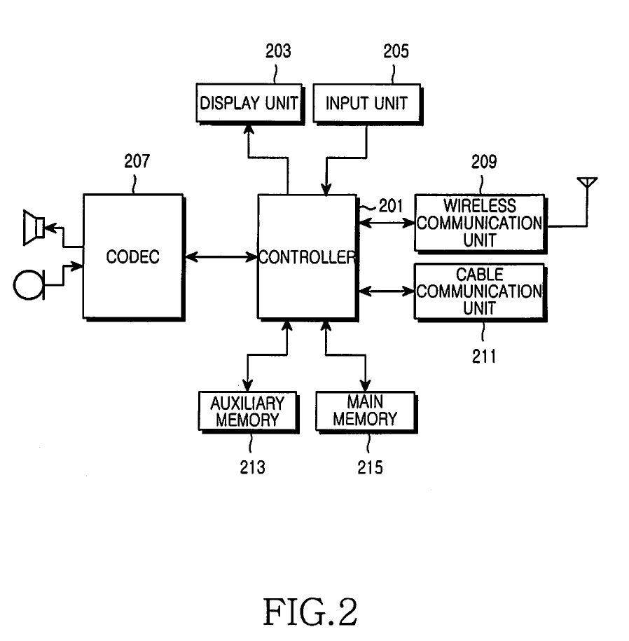

FIG. 2 is a block diagram of a portable terminal according to the present invention. Examples of the portable terminal are a cellular phone, a Personal Communication System (PCS) terminal, a Personal Digital Assistant (PDA), and an International Mobile Telecommunications-2000 (IMT-2000) terminal. The following description is made in terms of the general structure of the above terminals.

Referring to FIG. 2, the portable terminal includes an antenna, a microphone, a speaker, a controller 201, a display unit 203, an input unit 205, a Coder-Decoder (CODEC) 207, a wireless communication unit 209, a cable communication unit 211, an auxiliary memory 213, and a main memory 215.

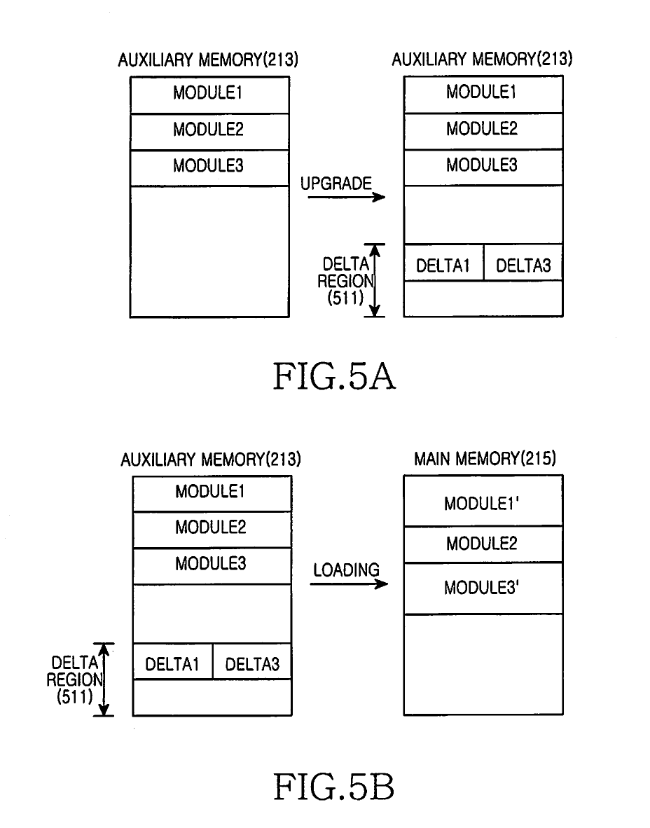

The controller 201 controls an overall operation of the portable terminal. For example, the controller 201 controls functions for voice communication and data communication. In addition to the general functions, the controller 201 controls a function for downloading a delta file through wireless communication, via the wireless communication unit 209, or cable communication, via the cable communication unit 211, to upgrade a software program stored in the auxiliary memory 213 and a function for loading the upgraded software program into the main memory 215. The delta file refers to an additional installation file for upgrading the software program. To upgrade the software program, the controller 201 stores the delta file in a delta region 511 and stores the matching information of the delta file and the corresponding software module, as illustrated in FIG. 5A. The delta region refers to an additional installation region for delta files. To load the upgraded software program, the controller 201 loads the corresponding software module, upgraded with the delta file, into the main memory 215, as illustrated in FIG. 5B.

The display unit 203 displays status information generated during the operation of the portable terminal, such as numerals, characters, pictures, etc. The input unit 205 provides the controller 201 with key input data corresponding to keys pressed by a user.

The CODEC 207 converts digital data received from the controller 201 into analog audio signals and outputs the analog audio signals through the speaker. In addition, the CODEC 207 converts analog audio signals received from the microphone into digital data and provides the digital data to the controller 201. The wireless communication unit 209 processes radio-frequency (RF) signals that are transmitted/received through the antenna. The cable communication unit 211 processes signals that are transmitted/received through a cable connected to an external device (e.g., a personal computer (PC)).

The auxiliary memory 213 stores an OS program, software programs such as application programs, and delta files for program upgrades. For example, the auxiliary memory may be flash memory.

The main memory 215 temporarily stores the OS program, an application program for a desired task, and data that is generated during the execution of the application program. For example, during execution of a software program, the main memory 215 temporarily stores the software program that is loaded from the auxiliary memory 213.

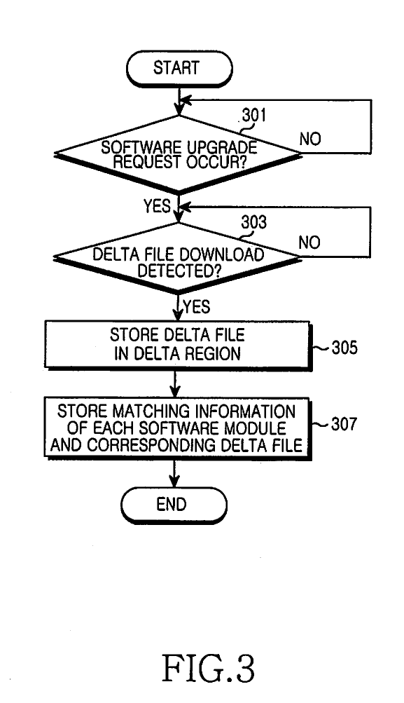

FIG. 3 is a flowchart of a procedure for upgrading software in the portable terminal according to the present invention.

Referring to FIG. 3, the controller 201 determines in step 301 if a software upgrade request occurs. For example, the controller 201 determines if an application program for software upgrade is executed by the user's manipulation. If the software upgrade request occurs, the procedure proceeds to step 303, otherwise, step 301 is repeated.

In step 303, the controller 201 determines if a delta file is downloaded. If the delta file has been downloaded, the procedure proceeds to step 305, otherwise, step 303 is repeated. The delta file refers to an additional installation file for the software upgrade. The delta file may be downloaded through wireless communication or through cable communication.

In step 305, the controller 201 stores the downloaded delta file in a delta region of the auxiliary memory 213. For example, the controller 201 stores the delta file in a delta region 511 of the auxiliary memory 213 as illustrated in FIG. 5A. The size and location of the delta region 511 may be adjusted according to various circumstances.

In step 307, the controller 201 stores matching information of each software module and a corresponding delta file. Since there is no relationship between the storage locations of each software module and the corresponding delta file, the matching information must be additionally stored so that each software module and the corresponding delta file can be loaded together for execution.

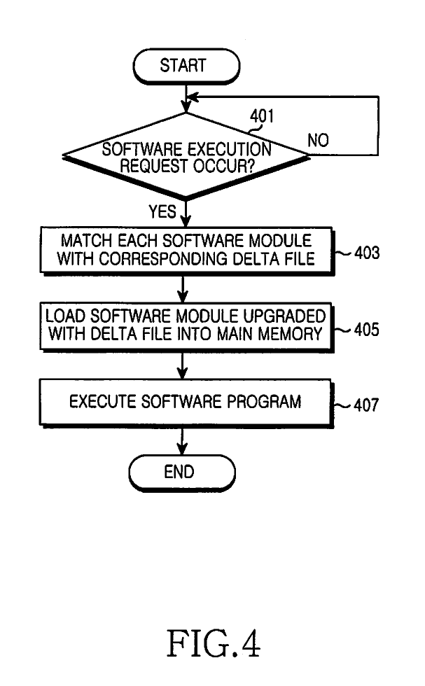

FIG. 4 is a flowchart of a procedure for executing the upgraded software in the portable terminal according to the present invention.

Referring to FIG. 4, the controller 201 determines in step 401 if a software execution request occurs, for example, by the user's manipulation. If the software execution request occurs, the procedure proceeds to step 403, otherwise, step 401 is repeated.

In step 403, the controller 201 matches software modules stored in the auxiliary memory 213 to corresponding delta files stored in the delta region.

In step 405, the controller 201 loads the software modules upgraded with the corresponding delta files into the main memory 215. For example, as illustrated in FIG. 5B, the software modules stored in the auxiliary memory 213 are matched to the corresponding delta files stored in the delta region 511 of the auxiliary memory 213, and the software modules upgraded with the corresponding delta files are loaded into the main memory 215.

In step 407, the controller 201 executes the upgraded software.

As described above, the present invention stores the delta files in the same delta region of the portable terminal during the software upgrade, without discriminating between the software modules corresponding to the delta files, i.e., instead of storing the delta files in the corresponding reserved spaces for the corresponding software modules. This makes it unnecessary to set the reserved spaces during the initial software installation. Accordingly, it is possible to prevent a waste of the auxiliary memory. In addition, the main memory can be prevented from being wasted due to the unnecessary loading of an empty reserved space during the software loading. Furthermore, it is possible to easily store even the delta file that has a larger size than the reserved space.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for upgrading software in a portable terminal, the method comprising the steps of:
determining if additional installation files for the software upgrade are downloaded;
storing the additional installation file in an additional installation region of a memory without discrimination between software modules; and
storing the matching information of the additional installation files and the software modules.

2. The method of claim 1, wherein the additional installation files are downloaded through one of wireless communication and through cable communication.

3. A method for executing software in a portable terminal, the method comprising the steps of:
matching an additional installation file to a corresponding software module stored in a first memory;
loading the software module upgraded with the additional installation file into a second memory; and
executing the upgraded software.

4. The method of claim 3, wherein the matching of the additional installation file to the corresponding software module is performed on the basis of prestored matching information.

5. A portable terminal comprising:
a memory for storing software modules and additional installation files; and
a controller performing a control operation for storing the additional installation files in an additional installation region of the memory without discrimination between the software modules corresponding to the additional installation files and a control operation for storing the matching information of the additional installation files and the corresponding software modules.

6. The portable terminal of claim 5, further comprising a wireless communication unit for downloading the additional installation files through wireless communication.

7. The portable terminal of claim 5, further comprising a cable communication unit for downloading the additional installation files through cable communication.

8. The portable terminal of claim 5, wherein the memory is a flash memory.

9. A portable terminal comprising:
a first memory for storing software modules and additional installation files;
a second memory for storing the software modules and the additional installation files temporarily for software execution; and
a controller performing a control operation for matching the additional installation files to the corresponding software modules and a control operation for storing the software modules upgraded with the corresponding additional installation files into the second memory.

10. The portable terminal of claim 9, wherein the first memory is a flash memory.
